(19) United States
(12) Patent Application Publication
(10) Pub. No.: US 2025/0074335 A1
(43) Pub. Date: Mar. 6, 2025

(54) TRIM ELEMENT ASSEMBLY COMPRISING CLIPPED CARRIER MEMBER AND SECOND MEMBER ELEMENT, AND ASSOCIATED ASSEMBLING METHODS

(71) Applicant: Faurecia Interieur Industrie, Nanterre (FR)

(72) Inventors: Javier CUMPLIDO ALCOCER, VALENCIA (ES); Alejandro SOSPEDRA, Paterna (ES); Noelia ROMERO, Paterna (ES)

(21) Appl. No.: 18/815,032

(22) Filed: Aug. 26, 2024

(30) Foreign Application Priority Data
Aug. 31, 2023 (FR) FR 2309149

(51) Int. Cl. B60R 13/02; B60R 7/12

(52) U.S. Cl. CPC B60R 13/0243; B60R 7/12

(57) ABSTRACT

A trim element assembly having a carrier member and a second member element. The carrier member includes a first protrusion with at least one hook portion. The second member element includes a second protrusion having at least one first branch, at least one second branch, and at least one bottom. The first protrusion cooperates with the second protrusion and extends between the at least one first branch and the at least one second branch along a longitudinal direction. The at least one bottom extends in regard to the first protrusion along a transversal direction and the hook portion is arranged in regard to the second member element in the opposite transversal direction. Associated assembling methods are also provided.

### TECHNICAL FIELD

The present invention relates to a trim element assembly comprising a carrier member and a second member element, and to associated assembling methods.

The present invention is in particular applicable for providing an umbrella storage within the trim assembly of a vehicle.

### BACKGROUND

KR20130115682 A describes an umbrella storage part for a vehicle below a door entrance. The umbrella storage part is provided with a storage space and a cover adapted to cover the storage space, with a fixing portion to maintain an umbrella in the space.

However, the umbrella storage part requires opening the cover every time someone wants to have access to the space.

The umbrella storage part does not provided a sturdy assembly, such that the trim element may be quite fragile.

Furthermore, the cover does not visually integrate within the vehicle.

### SUMMARY

One aim of the invention is thus to offer a trim element assembly comprising a carrier member and a second member element, that are fixed to one another, the trim element assembly being sturdy and aesthetic.

To that end, the invention relates to a trim element assembly comprising a carrier member and a second member element, the second member element being adapted to be clipped to the carrier member, the carrier member comprising a first surface, the first surface delimiting an opening and being provided with a first protrusion, the first protrusion comprising at least one hook portion at one end of the first protrusion, the second member element comprising a main portion and a second protrusion, the second protrusion comprising at least one first branch, at least one second branch and at least one bottom, the at least one first branch, the at least one bottom and the at least one second branch forming together a U-shape, the first protrusion cooperating with the second protrusion when the second member element and the carrier member are clipped together, such that the first protrusion extends between the at least one first branch and the at least one second branch along a longitudinal direction, the at least one bottom extends in regard to the first protrusion along a transversal direction, limiting the movement of the second member in the transversal direction, and the hook portion is arranged in regard to the second member element in the transversal direction in the opposite direction, limiting the movement of the second member in this opposite transversal direction.

The cooperation of the first protrusion and the second protrusion allows maintaining the second member element in place in regard to the carrier member along at least two direction, in a robust way. Further, the clipping offers an aesthetic finish

According to specific embodiments of the invention, the method also has one or more of the following features, considered alone or according to any technically possible combination(s):
the first protrusion is deformable, such that the hook portion is adapted to move in the longitudinal direction;
the longitudinal direction corresponds to a through-direction of the opening when the second member element and the carrier member are clipped together;
the first protrusion extends from a wall of the carrier member in a first direction away from the opening, the first direction being substantially the transversal direction when the second member element and the carrier member are clipped together;
the carrier member comprises a second surface, the second surface forming an angle between 70° and 110° with the first surface, the second surface being provided with at least one maintaining protrusion, the at least one maintaining protrusion being arranged on an opposite side of the opening relative to the first protrusion along the transversal direction, the second member element comprising a maintaining surface adapted to lie against the maintaining protrusion when the second member element and the carrier member are clipped together;
the trim element assembly is a door panel, the carrier member being a support panel;
the second member element is a cover, the cover being adapted to close the opening when the second member element and the carrier member are clipped together;
the second member element delimits with the carrier member a cavity when the second member element and the carrier member are clipped together, the cavity being accessible through the opening and being adapted to receive an umbrella.

The invention further relates to a method for assembling a trim element assembly as described above, the method comprising the following steps:
providing the carrier member and the second member element, and
moving the second member element towards the carrier element, such as to introduce the first protrusion between the at least one first branch and the at least one second branch and such that the at least one bottom extends in regard to the first protrusion, the first protrusion deforming during the movement such that the hook portion is arranged in regard to the second member element in the transversal direction in the opposite direction.

The invention further relates to the afore mentioned method, for assembling a trim element assembly as described above, wherein the moving of the second member element towards the carrier element is, such as to lay the maintaining surface between the maintaining protrusion and a wall delimiting an edge of the opening along the longitudinal direction.

### BRIEF DESCRIPTION OF THE DRAWINGS

Other features and advantages of the invention will appear upon reading the following description, provided solely as an example and done in reference to the appended drawings, in which:

FIG. 1 is a three-dimensional representation of an example of a trim element assembly according to the invention,

FIG. 2 is a three-dimensional representation of a portion of the carrier member of the trim element assembly of FIG. 1,

FIG. 3 is a three-dimensional representation of the second member element of the trim element assembly of FIG. 1,

FIG. 4 is a three-dimensional representation of part of the second member element of FIG. 3,

FIG. 5 is a three-dimensional representation, with a section along plan A-A of FIG. 1, of the cooperation of the first protrusion and the second protrusion in the trim element assembly of FIG. 1, and

FIG. 6 is a three-dimensional representation of an alternative second member element.

### DETAILED DESCRIPTION

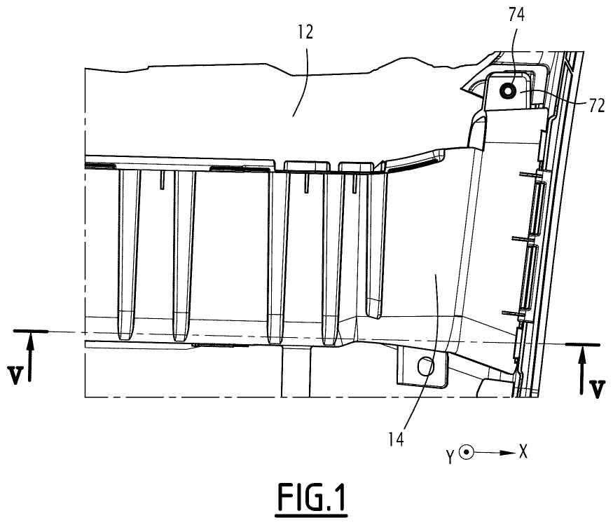

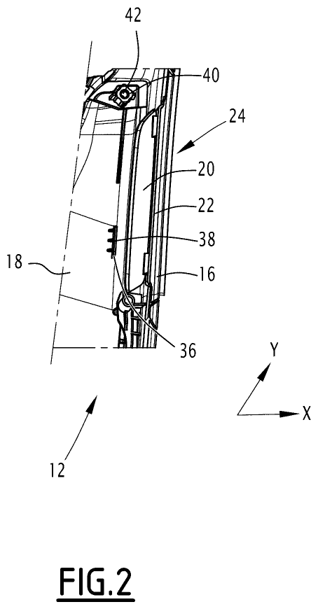

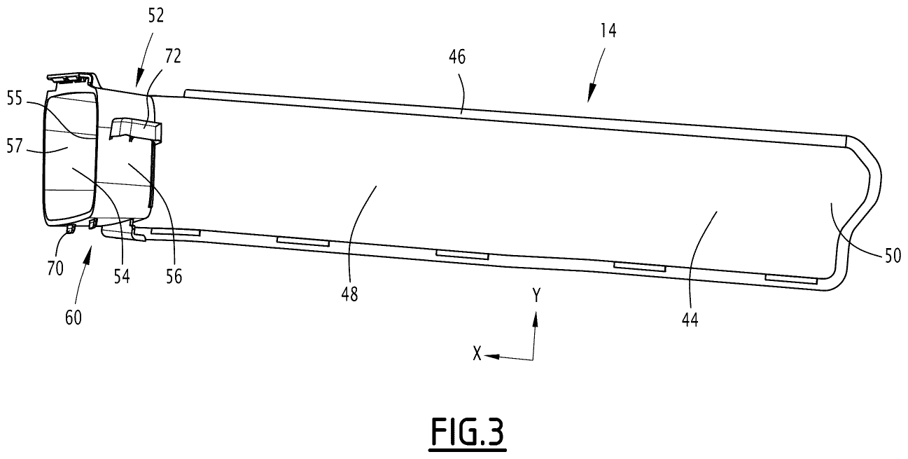

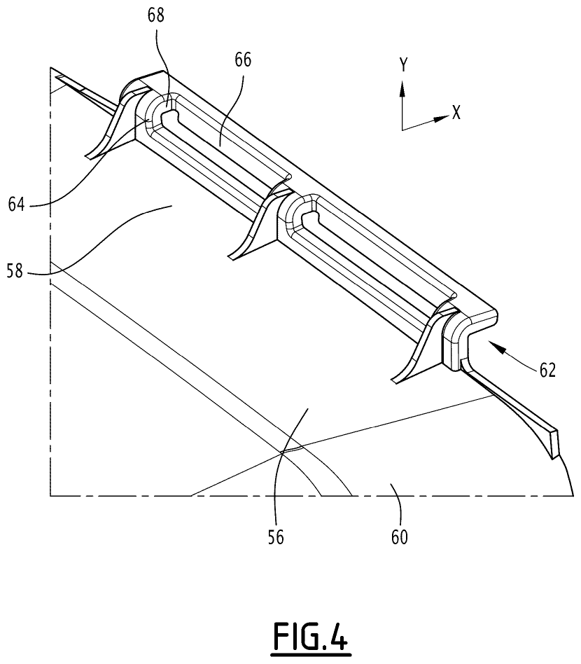

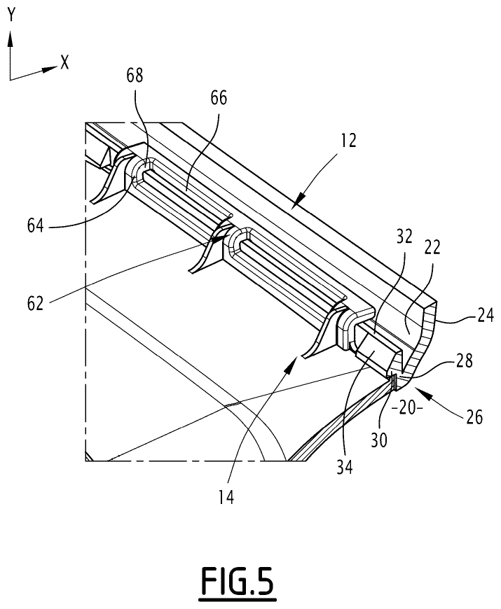

A first example of a trim element assembly 10, here for a vehicle, according to an embodiment of the invention is represented on FIGS. 1 to 5.

The trim element assembly is here a door panel.

The trim element assembly comprises a carrier member 12 and a second member element 14.

Each of a longitudinal direction X and a transversal direction Y are defined for each of the carrier member 12 and the second member element 14, and the respective longitudinal directions X and transversal directions Y are respectively aligned when the carrier member 12 and the second member element 14 are attached.

The second member element 14 is attached to the carrier member 12.

The carrier member 12 is here a support panel of the door panel.

The carrier member 12 comprises a first surface 16.

The carrier member 12 further comprises a second surface 18.

The second surface 18 is here a surface adapted to cover the door opening of the vehicle.

The first surface 16 is here a side of the carrier member 12, more particularly the side of the door opposite the attachment, here the hinge, between the door panel and the rest of the vehicle.

The first surface 16 extends from an edge of the second surface 18.

The second surface 18 forms an angle between 70° and 110° with the first surface 16.

The first surface 16 delimits an opening 20.

The opening 20 runs through the entire thickness of the first surface 16.

The opening 20 has a cross-section with dimensions, such as to allow the passage of an umbrella through the opening, more particularly of an umbrella in translation through the opening along the direction of extension of the umbrella.

The opening 20 defines a through-direction.

The through-direction corresponds to a longitudinal direction, as defined later.

The first surface 16 has an inner face 22 and an outer face 24.

The second member element 14 is adapted to cooperate with the inner face 22 of the first surface 16.

The inner face 22 lies in regard to the second surface 18.

The inner face 22 is provided within the door when the door panel is fully assembled.

The outer face 24 corresponds to the distal edge of the door relative to the vehicle. The outer face 24 is visible by the user, when the door panel is fully assembled.

The carrier member 12 does not define any obstacle adjacent the opening 20, on the inner side or on the outer side.

The first surface 16 is provided with a first protrusion 26.

The first protrusion 26 protrudes from the inner face 22.

The first protrusion 26 protrudes from the edge of the opening 20.

The first protrusion 26 protrudes in a first direction away from the opening 20.

The first protrusion 26 extends along a second direction, perpendicular to the first direction.

Here, the first surface around the opening 20 is curved, such that the inner face 22 is concave.

The first protrusion 26 extends from said inner face 22 surrounding the opening 20.

The first protrusion 26 protrudes substantially parallel to the plane of extension of the opening 20.

The first protrusion 26 comprises a main portion 28 and at least one hook portion 30.

The main portion 28 connects the at least one hook portion 30 to the rest of the carrier member 12.

The main portion 28 here extends from the inner face 22.

The main portion 28 extends from the inner face 22 to a distal end 32.

The main portion 28 is here a rib.

The main portion 28 is planar.

The main portion 28 extends substantially perpendicular to the through-direction of the opening 20.

The first protrusion 26, more precisely the main portion 28, extends along, more precisely protrudes from, at least half of a distal edge of the opening 20. The distal edge of the opening 20 is the portion of the edge of the opening 20 the furthest from the second surface 18.

Here, the main portion 28 extends along all the distal edge of the opening 20.

The height of the main portion 28, measured from the inner face 22 to the distal end 32, is constant along the length of the first protrusion 26.

The at least one hook portion 30 is arranged at one end of the first protrusion 26, here along the second direction.

More precisely, the first protrusion 26 here comprises a hook portion 30 at each end of the first protrusion along the second direction.

The or each hook portion 30 extends from the main portion 28, here from the distal end 32 of the main portion 28.

The or each hook portion 30 comprises a slanted face 34.

The slanted face 34 extends from an inner edge of the distal end 32 at an acute angle with the main portion 28.

The angle is, for example, comprised between 25° and 60°.

The first protrusion 26, more particularly the main portion 28, is deformable, such that the hook portion 30 can move in the longitudinal direction, here perpendicularly to the main portion 28 at rest. In particular, when a force is applied on the slanted surface 34, the hook portion 30 comes closer to the inner face 22 of the first surface 16.

The second surface 18 is provided with at least one maintaining protrusion 36.

The at least one maintaining protrusion 36 is arranged on an opposite side of the opening 20 relative to the first protrusion 26, here in regard to a proximal edge of the opening 30 in opposition with the previously mentioned distal edge.

The proximal edge of the opening is the portion of the edge of the opening the closest to the second surface 18.

The proximal edge and the distal edge are opposite edges of the opening according to a transversal direction Y.

The first direction is substantially parallel to the transversal direction.

The second surface 18 is here provided with a plurality of maintaining protrusions 36.

The plurality of maintaining protrusions are here arranged along a direction perpendicular to the through-direction of the opening 20 and to the transversal direction.

The or each maintaining protrusion form a retaining face 38.

The retaining face 38 is substantially perpendicular to the through-direction of the opening 20.

The retaining face 38 faces the proximal edge of the opening or a portion of the first surface lying between the proximal edge and the second surface along the transversal direction, in the through-direction of the opening.

The distance measured along the through-direction between the retaining face 38 and the proximal edge of the opening or said portion is comprised between 3 mm to 2 cm.

The or each maintaining protrusion 36 protrudes from the second surface 18 in the transversal direction Y.

In the depicted example, the second surface is further provided with a least one structure 40 delimiting a threaded hole 42.

The threaded hole 42 extends along the transversal direction.

The threaded hole 42 is a blind hole.

In a first embodiment, the second member element 14 delimits with the carrier member 12 a cavity 44 when the second member element and the carrier member are attached together, the cavity 44 being accessible through the opening 20 and being adapted to receive an umbrella.

Thus, a user can store an umbrella in the cavity 44. When the vehicle is moving, the door is closed, such that the opening 20 is not accessible and closed by the rest of the vehicle and the umbrella is safely stored inside the cavity. When the door is open (for example when the user gets in or out the vehicle), the opening 20, and thus the cavity 44, are accessible, such that he can place or withdraw an umbrella from the cavity 44 if need be.

The cavity offers a practical and particularly aesthetic and integrated solution to store an umbrella.

More particularly, the second member element 14 here comprises at least one lateral wall 46, 48 and an end wall 50 delimiting with the carrier member 12 the cavity 44.

The second member element 14 comprises a front portion 52 adapted to be rigidly connected to the carrier member 12 around the opening 20.

The front portion 52 delimits a corresponding through-opening 54, the corresponding through-opening 54 extending in continuity with the opening 20.

The corresponding through-opening 54 has dimensions corresponding to the dimension of the opening 20.

The front portion 52 surrounds the corresponding through-opening 54.

More particularly, the front portion 52 comprises a peripheral wall 56 surrounding the corresponding through-opening 54.

The peripheral wall 56 has an end section 55, the end section 55 being an extremity of the second member element 14 along the longitudinal direction X.

The peripheral wall 56, more particularly the end section 55, lies in the continuity of the edge of the opening 20.

The transition between the opening 20 and the corresponding through-opening 54 allows a satisfying aesthetics.

The peripheral wall 56 has an inner face 57 surrounding the corresponding through-opening 54 and an outer face 58.

The lateral wall(s) 46, 48 extend from the peripheral wall 56 away from the corresponding through-opening 54.

The end wall 50 extend from an extremity of the lateral wall(s) 46, 48 opposite the peripheral wall 56.

The second member element 14 comprises a main portion 60 and a second protrusion 62.

In the first embodiment, the main portion 60 comprises the peripheral wall 56, and here the lateral wall(s) 46, 48 and the end wall 50.

The second protrusion 62 comprises at least one first branch 64, at least one second branch 66 and at least one bottom 68.

The at least one first branch 64, the at least one bottom 68 and the at least one second branch 66 form together a U-shape.

The union of the sections of the second protrusion 62 in X, Y planes form the U-shape.

The at least one first branch 64 protrudes from the main portion 60, more particularly from the peripheral wall 56, more particularly from the outer face 58 of the peripheral wall 56.

The at least one first branch 64 protrudes here from the outer face 58 of the end section 55 of the peripheral wall 56.

The at least one first branch 64 protrudes from the main portion 60 in a first branch direction.

The first branch direction corresponds to the transversal direction.

Here, the second protrusion 62 comprises a plurality of, here three, first branches 64.

The first branches 64 are here aligned in a direction perpendicular to the transversal direction and the through-direction of the corresponding through-opening 54.

The first branches 64 protrudes from a same side of the peripheral wall, in regard to the corresponding through-opening 54.

The at least one bottom 68 extends from a distal end of the at least one first branch 64, in a longitudinal direction X.

The or each bottom 68 extends from the at least one first branch in the direction going from the corresponding through-opening 54 to the opening 20.

Here, the or each bottom 68 extends away from the second member element 14 along the longitudinal direction X.

The longitudinal direction X corresponds to the through-direction of the opening 20, and here of the corresponding through-opening 54.

More particularly, a bottom 68 extends from the distal end of each first branch 64.

The at least one second branch 66 extends from the at least one bottom 68, more particularly from an end of the bottom opposite the at least one first branch.

The at least one second branch 66 extends parallel to the first branch direction.

Here, the or each second branch 66 connects two adjacent bottoms 68 along the direction perpendicular to the longitudinal direction X and the transversal direction Y.

The or each second branch 66 has a face perpendicular to the through-direction of the corresponding through-opening 54.

The second member element 14 further comprises at least one maintaining surface 70.

The at least one maintaining surface 70 protrudes from the outer face 58 of the peripheral wall 56, more particularly along the transversal direction Y.

The at least one maintaining surface 70 protrudes from the peripheral wall 56 opposite the second protrusion 62 in regard to the corresponding through-opening 54, in particular opposite in the transversal direction Y.

The second member element 14 further comprises a tab 72 delimiting a hole 74.

The hole 74 is, for example, threaded.

Alternatively, the hole 74 is not threaded.

The hole 74 extends along the transversal direction.

The hole 74 is a through-hole.

The hole 74 and the threaded hole 42 line up, such that a screw can be screwed through both threaded holes to secure the carrier member 12 and the second member element 14 together.

The second member element 14 is here clipped to the carrier member 12.

More precisely, the first protrusion 26 cooperates with the second protrusion 62 when the second member element 14 and the carrier member 12 are clipped together.

The first protrusion 26 extends between the at least one first branch 64 and the at least one second branch 66 along the longitudinal direction X.

The at least one bottom 68 extends in regard to the first protrusion 26 along the transversal direction Y. The hook portion 30 is arranged in regard to the second member element 14, more particularly the main body, in the transversal direction Y in the opposite direction. Thus, the hook portion 30 acts as a stop in the transversal direction Y, opposite the at least one bottom 68.

Thus, the cooperation of the first protrusion 26 and the second protrusion 62 maintains together the second member element 14 and the carrier member 12 in the longitudinal direction X and the transversal direction Y in both ways.

Furthermore, here, the maintaining surface 70 is adapted to lie against the maintaining protrusion 36 when the second member element 14 and the carrier member 12 are clipped together.

More particularly, the maintaining surface 70 is arranged, along the longitudinal direction X, between the retaining face 38 and the proximal edge of the opening 20 or a portion of the first surface lying between the proximal edge and the second surface along the transversal direction.

This enables a supplementary hold of the second member element 14 and the carrier member 12 together in the longitudinal direction, opposite the cooperation of the protrusions 26, 62.

The second member element 14 and the carrier member 12 are, for example, also screwed together, more particularly via a screw screwed through both holes 42, 74.

The assembly of the second member element 14 and the carrier member 12 is particularly sturdy.

The door panel, for example, further comprises a cover panel (not represented) assembled on the carrier member 12 after the assembly of the second member element 14 and the carrier member 12, such as to close the door panel. The cover panel and the carrier member form together the outside of the vehicle door. The inner face of the carrier member 12 and the outer face of the second member element 14 are no longer accessible.

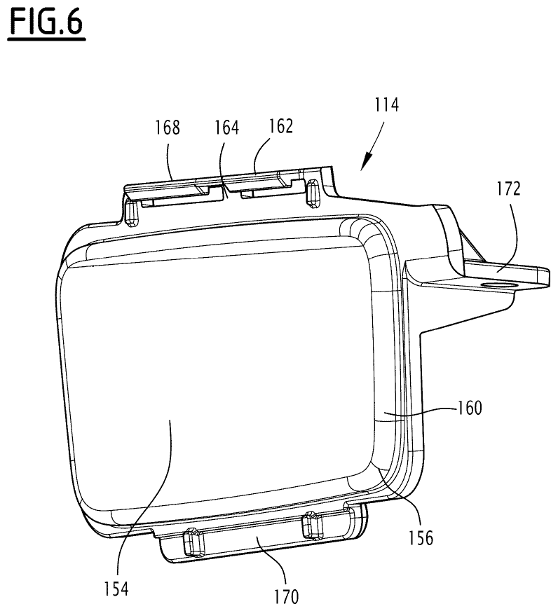

On FIG. 6, is depicted an example of an alternate second member element 114.

In said embodiment, the second member element 114 is a cover, the cover being adapted to close the opening 20 when the second member element 114 and the carrier member 12 are clipped together.

The second member element 114 comprises a main portion 160 and a second protrusion 162.

The main portion 160 comprises a cover wall 154 adapted to close the opening 20 when the second member element 114 and the carrier member 12 are clipped together.

Thus, when no storage for umbrella is wanted, said second member element 114 is clipped to the carrier member 12, instead of the first embodiment of the second member element 14. The second member element 114 closes the opening 20 to prevent access to the inside of the door panel and to finish the door.

It is thus possible to provide an umbrella storage or no umbrella storage easily, using the same carrier member 12, by simply switching the second member element to be attached to the carrier member, in particular on the assembly line of the vehicle.

The cover wall 154 comprises a border 156.

The second protrusion 162 is similar to the second protrusion 62 described previously.

Only aspects from which they differ will now be described.

Similarly, the at least one first branch 164 protrudes from the main portion 160, here from the border 156.

The or each bottom 168 extends from the at least one first branch in the direction going from the cover wall 154 to the opening 20.

The second member element 114 further comprises at least one maintaining surface 170.

The at least one maintaining surface 170 protrudes from the border 156, more particularly along the transversal direction Y.

The at least one maintaining surface 170 protrudes from the border 156 opposite the second protrusion 162 in regard to the cover wall 154.

The second member element 114 further comprises a tab 172, similar to the tab 72 described previously.

The second member element 114 is attached to the carrier member 12, similarly as the second member element 14 per the first embodiment.

A method for assembling a trim element assembly as described previously will now be described.

A carrier member 12 and a second member element 14, 114, according to any of the embodiments, are provided.

The second member element 14; 114 is moved towards the carrier member 12.

In the represented embodiment, the second member element 14; 114 is moved such as to place the maintaining surface 70; 170 between the maintaining protrusion 36 and a wall delimiting an edge of the opening 20, along the longitudinal direction X, more particularly, between the retaining face 38 and the proximal edge of the opening 20 or the portion of the first surface lying between the proximal edge and the second surface.

The introduction of the maintaining surface 70; 170 is here done before the cooperation of the first protrusion 26 and the second protrusion 62.

The second member element 14; 114 is here moved such as to introduce the first protrusion 26 between the at least one first branch 64 and the at least one second branch 66 and such that the at least one bottom 68 extends in regard to the first protrusion 26, the first protrusion deforming during the movement such that the hook portion 30 is arranged in regard to the second member element 14; 114 in the transversal direction Y in the opposite direction.

The movement is, for example, a translation along the transversal direction Y, in particular in regard to FIGS. 1 to 3, or a rotation around the maintaining surface 170, in particular in regard to FIG. 6. More particularly, during the movement, at the beginning of the cooperation between the first protrusion 26 and the second protrusion 62, the second member element 14; 114 pushes on the slanted surface 34, such that the first protrusion 26 deforms. The hook portion 30 comes closer to the inner face 22 of the first surface 16, such as to allow the passage of the main portion of the second member element 14; 114.

Thus, the first protrusion 26 is maintained between the at least one first branch 64 and the at least one second branch 66 along the longitudinal direction X and between the at least one bottom 68 and the main portion of the second member element 14; 114.

The carrier member 12 and the second member element 14; 114 are thus clipped in together.

Lastly, the second member element 14, 114 and the carrier member 12 are, for example, also screwed together, more particularly via a screw screwed through both holes 42, 74.

The assembly of the carrier member 12 and the second member element 14, 114 is thus particularly easy through clipping and eventual additional screwing. In particular, there is no need for welding the pieces together.

The resulting trim assembly, in particular door panel, is sturdy and aesthetically pleasing, with a smooth finish.

1. Trim element assembly comprising a carrier member and a second member element, the second member element being adapted to be clipped to the carrier member, the carrier member comprising a first surface, the first surface delimiting an opening and being provided with a first protrusion, the first protrusion comprising at least one hook portion at one end of the first protrusion, the second member element comprising a main portion and a second protrusion, the second protrusion comprising at least one first branch, at least one second branch and at least one bottom, the at least one first branch, the at least one bottom and the at least one second branch forming together a U-shape, the first protrusion cooperating with the second protrusion when the second member element and the carrier member are clipped together, such that the first protrusion extends between the at least one first branch and the at least one second branch along a longitudinal direction, the at least one bottom extends in regard to the first protrusion along a transversal direction, limiting the movement of the second member in the transversal direction, and the hook portion is arranged in regard to the second member element in the transversal direction in the opposite direction, limiting the movement of the second member in this opposite transversal direction.

2. Trim element assembly according to claim 1, wherein the first protrusion is deformable, such that the hook portion is adapted to move in the longitudinal direction.

3. Trim element assembly according to claim 1, wherein the longitudinal direction corresponds to a through-direction of the opening when the second member element and the carrier member are clipped together.

4. Trim element assembly according to claim 1, wherein the first protrusion extends from a wall of the carrier member in a first direction away from the opening, the first direction being substantially the transversal direction when the second member element and the carrier member are clipped together.

5. Trim element assembly according to claim 1, wherein the carrier member comprises a second surface, the second surface forming an angle between 70° and 110° with the first surface, the second surface being provided with at least one maintaining protrusion, the at least one maintaining protrusion being arranged on an opposite side of the opening relative to the first protrusion along the transversal direction, the second member element comprising a maintaining surface adapted to lie against the maintaining protrusion when the second member element and the carrier member are clipped together.

6. Trim element assembly according to claim 1, wherein the trim element assembly is a door panel, the carrier member being a support panel.

7. Trim element assembly according to claim 1, wherein the second member element is a cover, the cover being adapted to close the opening when the second member element and the carrier member are clipped together.

8. Trim element assembly according to claim 1, wherein the second member element delimits with the carrier member a cavity when the second member element and the carrier member are clipped together, the cavity being accessible through the opening and being adapted to receive an umbrella.

9. Method for assembling a trim element assembly according to claim 1, the method comprising the following steps:
providing the carrier member and the second member element, and
moving the second member element towards the carrier element so as to position the first protrusion between the at least one first branch and the at least one second branch and such that the at least one bottom extends in regard to the first protrusion, the first protrusion deforming during the movement such that the hook portion is arranged in regard to the second member element in the transversal direction in the opposite direction.

10. Method according to claim 9, wherein the carrier member comprises a second surface, the second surface forming an angle between 70° and 110° with the first surface, the second surface being provided with at least one maintaining protrusion, the at least one maintaining protrusion being arranged on an opposite side of the opening relative to the first protrusion along the transversal direction, the second member element comprising a maintaining surface adapted to lie against the maintaining protrusion when the second member element and the carrier member are clipped together, wherein the moving of the second member element towards the carrier element is done so as to lay the maintaining surface between the maintaining protrusion and a wall delimiting an edge of the opening along the longitudinal direction.
